(19) United States
(12) Patent Application Publication
(10) Pub. No.: US 2003/0036046 A1
(43) Pub. Date: Feb. 20, 2003

(54) System and method for providing an outline tutorial

(76) Inventor: David Smolover, Lakeside, CT (US)

Correspondence Address: Elizabeth P. Morano, Bromberg & Sunstein LLP, 125 Summer Street, Boston, MA, 02110-1618, US

(21) Appl. No.: 10/200,605

(22) Filed: Jul. 22, 2002

Related U.S. Application Data
(60) Provisional application No. 60/307,025, filed on Jul. 20, 2001.

(51) Int. Cl. G09B 3/00

(52) U.S. Cl. 434/350

(57) ABSTRACT

A system provides educational instruction to a student over a network. The system includes an education service provider in communication with the computer network and a teacher database containing teacher information relevant to a plurality of teachers. The system may further include a student database containing student information relevant to at least one student. The education service provider is capable of providing a lesson track to the at least one student, the lesson track being produced based upon the teacher information and the student information.

### PRIORITY

The present application claims priority from U.S. Provisional Application No. 60/307,025, incorporated herein, in its entirety, by reference.

### TECHNICAL FIELD

The present invention relates to teaching systems and methods and, more particularly, to a system and method for providing a tutorial over a network.

### BACKGROUND ART

Educational instruction commonly is provided over a network (e.g., the Internet). For example, a student user may access a web site to receive instruction for a standardized curriculum offered by the organization maintaining the web site. A standardized curriculum, however, typically is not customized to the needs of a particular student.

Some currently available web-based educational programs thus individualize instruction based upon a particular student's profile only. Using only the student's profile for these purposes, however, undesirably can cause the instruction to be ineffective or inefficient.

### SUMMARY OF THE INVENTION

In accordance with one embodiment of the invention, a method for educating a student includes ascertaining an area of expertise and a teaching style for each of a plurality of teachers and ascertaining a learning style and learning preferences of at least one student. The student is then provided with one or more teachers and lessons based on the each teacher's area of expertise and style of teaching in conjunction with the student's learning style and learning preferences. Providing the student with one or more teachers and one or more lessons may include inputting information relevant to each teacher's area of expertise and style of teaching into a computer based system and inputting information relevant to the student's learning style and learning preferences into the computer based system. The computer based system may be programmed to analyze the information, match the student to one or more teachers suited to the student in accordance with the information, and output the lessons.

In accordance with another embodiment of the invention, a system for providing educational instruction to a student over a computer network includes an education service provider in communication with the computer network and a teacher database containing teacher information relevant to a plurality of teachers. The system further includes a student database containing student information relevant to at least one student. The education service provider then provides a lesson track to the at least one student. The lesson track is produced based upon the teacher information and the student information. In accordance with a related embodiment, the teacher database may include a teacher profile. Similarly, the teacher database may include information relevant to each teacher's teaching philosophy, and/or information relevant to each teacher's personality traits. The teacher database may also include a rank for each teacher based on student input and/or a rank for each teacher based on analysis by the education service provider. In accordance with a further related embodiment, the network may be the Internet. The lesson track may be provided to the student via an interactive graphical user interface, and the interface may be customized for the student based on information in the student database. In accordance with yet another related embodiment, the education service provider may match the student to a primary teacher in accordance with the teachers' expertise and style of teaching and with the student's education preferences and provide the student with a lesson track devised by the primary teacher. Similarly, wherein the education service provider may also provide the student with a lesson track devised by one or more secondary teachers.

In accordance with a further embodiment of the invention, a method for providing educational instruction to a student over a network includes ascertaining teacher information relating to a plurality of teachers and storing the teacher information in a teacher database. At least one student is profiled via the network and student information relevant to the student's profile is stored in a student database. The student is then provided with a lesson track based upon the teacher information and the student information.

In accordance with another embodiment of the invention, a method for providing education to a student over a network includes gathering information relevant to a plurality of teachers and creating a teacher profile for each teacher in accordance with each teacher's expertise and style of teaching. Student information relevant to at least one student is gathered via a network and a student profile based upon the student information is created. The student is provided with a lesson track, via the network, based on analysis of the teacher profile and the student profile.

In accordance with a further embodiment of the invention, a system for providing educational instruction to a student over a network includes an education service provider in communication with the network. The education service provider includes an interface for receiving teacher information relevant to a plurality of teachers and for receiving student information relevant to at least one student and provides a lesson track to the at least one student based upon both the student information and the teacher information.

In accordance with a further embodiment of the invention, a computer program product for educating a student is provided. The computer program product includes a computer usable medium having computer readable program code. The computer readable program code also includes program code for providing the student with one or more teachers and one or more lessons based on each teacher's area of expertise and style of teaching in conjunction with the student's learning style and learning preferences. The computer readable program code may also include program code for ascertaining an area of expertise and a teaching style for each of a plurality of teachers and program code for ascertaining a learning style and learning preferences of at least one student.

### BRIEF DESCRIPTION OF THE DRAWINGS

The foregoing features of the invention will be more readily understood by reference to the following detailed description, taken with reference to the accompanying drawings, in which:

FIG. 1 is a flow chart illustrating a method of providing education to a student in accordance with one embodiment of the invention.

FIG. 2 is a block diagram illustrating a system in accordance with another embodiment of the invention;

FIG. 3 is an illustration of information saved to a teacher database in accordance with another embodiment of the present invention;

FIG. 4 is an illustration of a graphical user interface for displaying a teacher profile in accordance with another embodiment of the invention;

FIG. 5 is an illustration of typical criteria presented to a student to enable the student to evaluate a teacher;

FIG. 6 is an illustration of an interactive graphical user interface for profiling a student in accordance with another embodiment of the invention;

FIG. 7 is another illustration of an interactive graphical user interface for profiling a student in accordance with the embodiment of FIG. 6;

FIG. 8 is an illustration of a graphical environment for an adult Rock student;

FIG. 9 is an illustration of a graphical environment for an adult Acoustic student;

FIG. 10 is an illustration of a graphical environment for a male teenage student;

FIG. 11 is a block diagram illustrating a lesson track in accordance with an embodiment of the invention;

FIG. 12 is an illustration of an interactive graphical user interface for displaying a particular lesson track to a student in accordance with a further embodiment of the invention;

FIG. 13 is a block diagram illustrating two different lesson tracks in accordance with another aspect of the invention;

FIG. 14 is a block diagram illustrating a method by which a student may receive different explanations of a single subject matter in accordance with an aspect of the invention;

FIG. 15 is a block diagram illustrating a method by which a student may traverse different areas of a particular subject or discipline in accordance a further aspect of the invention;

FIG. 16 is a block diagram illustrating a multi-dimensional educational construct in accordance with another aspect of the invention;

FIG. 17 is an illustration of an interactive graphical user interface by which a student may traverse the history of his or her lessons;

FIG. 18 is a flow chart illustrating a method for providing education over a network in accordance with an embodiment of the invention;

FIG. 19 is a flow chart illustrating a method for providing education over a network in accordance with another embodiment of the invention;

FIG. 20 is an illustration of an interactive graphical user interface whereby a group lesson may be conducted; and

FIG. 21 is an illustration of an interactive graphical user interface whereby a student may be informed of group events associated with the educational system.

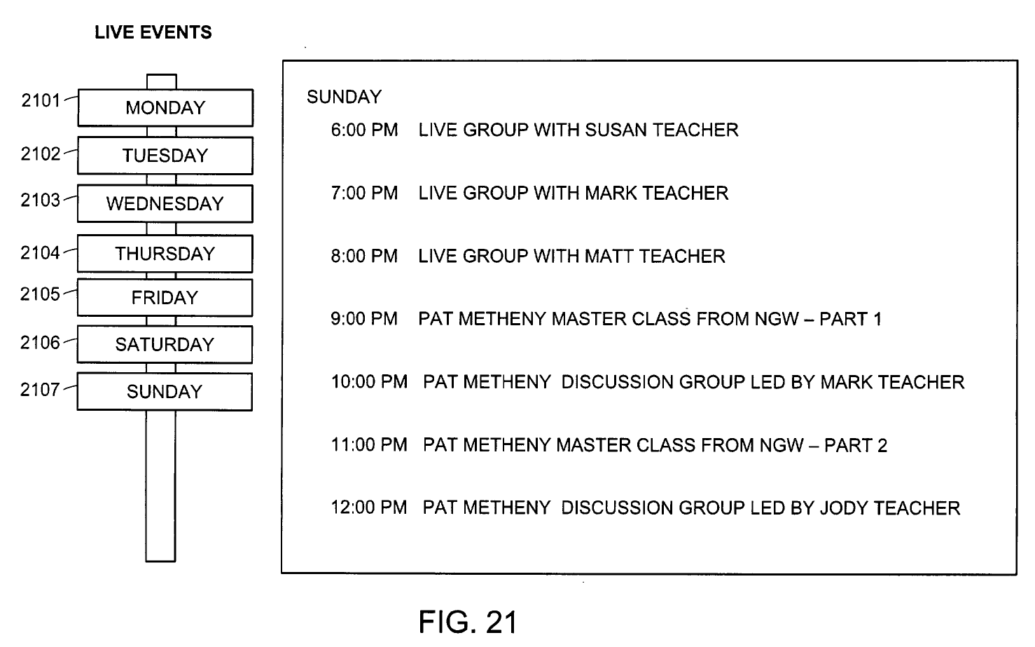

### DETAILED DESCRIPTION OF SPECIFIC EMBODIMENTS

Illustrative embodiments of the invention provide instruction to one or more students over a computer network in a customized manner that is based on both an individual teacher's profile and a student's profile. More specifically, an illustrative network based education provider matches a teacher to a student and provides the student with a customized lesson track. This matching is based upon both 1) the expertise and teaching style of an instructor and 2) a student's specific educational preferences. Details of various embodiments are discussed below.

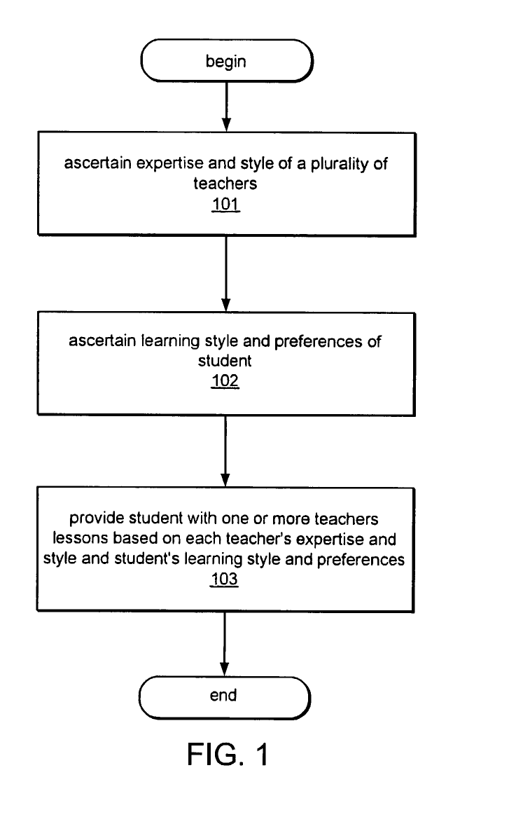

FIG. 1 illustrates a method of providing education to a student in accordance with one embodiment of the invention. An area of expertise and a teaching style is ascertained for each of a plurality of teachers in step 101. A learning style and learning preferences of at least one student are ascertained (step 102). The student is then provided, (step 103), with one or more teachers and one or more lessons based on the each teacher's area of expertise and style of teaching in conjunction with the student's learning style and learning preferences.

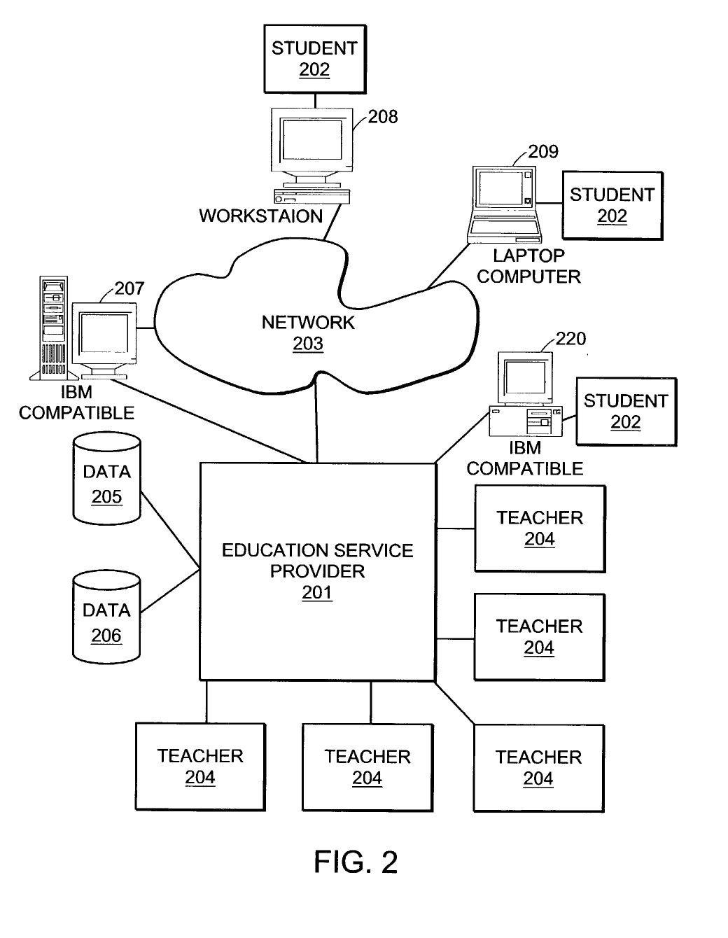

FIG. 2 illustrates an education system configured in accordance with another embodiment of the invention. The system includes an education service provider 201 that communicates with one or more students 202 over a computer network 203. The computer network 203 may be a LAN, WAN, the Internet or other network known in the art. Among other things, the education service provider 201 may employ graphical user interfaces and interactive audio and visual media devices. Such interfaces and devices may be provided by employing software produced by Riff Interactive, Inc., Microsoft, Inc. (e.g., Windows Media Play Version 7.0 or higher), and Macromedia, Inc. (e.g., the Macromedia Flash Player Version 5 higher). For example, sequential lesson tracks may be provided by employing software produced by Interwise ECP or software such as Learnlinc produced by Menturgy. Content management software, such as produced by Context Media, may also be employed.

The system also includes one or more instructors (or teachers) 204 that communicate with the one or more of the students 202 to provide synchronous lessons (such as “live” group lessons between a teacher and one or more students) and asynchronous lessons (which are generally provided through a lesson track, described beloww) via the education service provider 201. As noted above, each instructor 204 associated with the education provider 201 is individually assessed and profiled in terms of his or her specific traits. When used in the musical education context, for example, these traits may relate to the teacher's expertise with an instrument and style, his or her approach to particular subject matter, his or her teaching philosophy, his or her teaching techniques, his or personality traits and his or her gender. Initially, assessments may be conducted in a non-electronic manner upon hiring the teacher. Teacher profiles may then be entered into a teacher database 205, which also communicates with the service provider 201.

In accordance with the systems and methods described herein, the processes performed by the education services provider may also be performed in real time (with or without specific databases and storage structures). Similarly, student profiles and lesson tracks may be produced in real time.

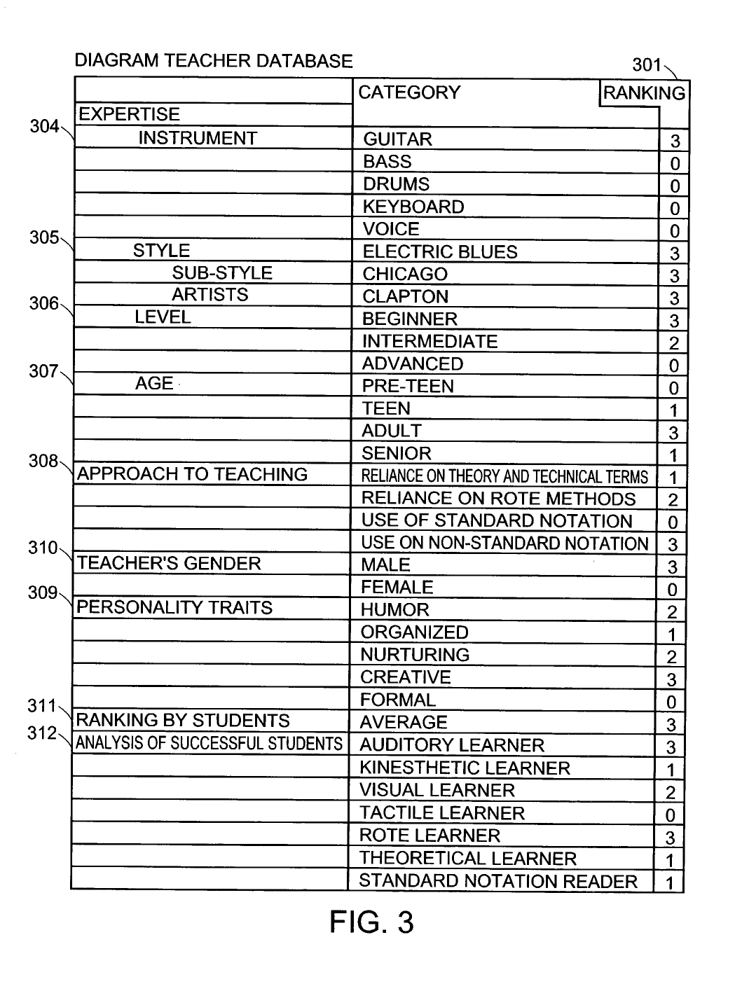

FIG. 3 shows an exemplary teacher information record in the teacher database 205. Some of the information in FIG. 2 also is noted above. This information may be periodically updated by performing ongoing teacher evaluations. For example, data may be obtained via student feedback and automatic system calculations (described below). It should be noted that the educational system discussed below primarily teaches musical education. Discussion of the educational system in this context, however, is exemplary only. Accordingly, various other embodiments may relate to other types of education, such as English, art or history. Discussion of musical education thus is not intended to limit the scope of all embodiments of the invention.

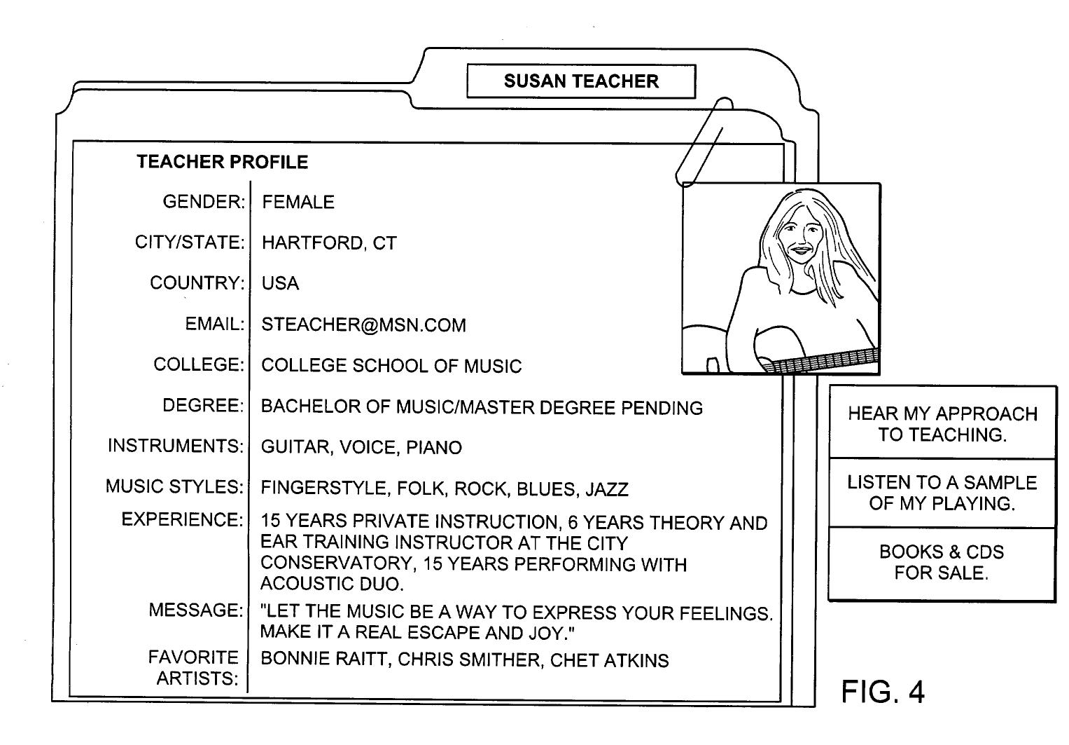

As shown in FIG. 3, the teacher database 205 contains information used to match a teacher to a student. Such information may include a teacher profile for a particular teacher and lesson tracks generated by that teacher. A system process (discussed below) sets a value for each datum in the record (shown in column 301) (for example, 0 may be the lowest value and 3 may be the highest value). These values are used to match the teacher with an appropriate student. Accordingly, when a student requests instruction, the system generates a list of recommended teachers based upon the noted values in column 301. The teacher that best matches a student's learning criteria appears highest on the list of suggested teachers. The system then directs the student to the highest rated instructor's lessons and, consequently, this instructor will be viewed as the student's primary teacher. However, in some embodiments, the student has the option to “interview” other teachers (via the interface of FIG. 4, for example), thus overriding the system's decision.

In illustrative embodiments, four categories are used to assess a teacher's expertise. In particular, those categories include instrument 304, style 305, typical skill level of the teacher's successful students 306, and typical age of the teacher's successful students 307. For example, a teacher may be categorized and ranked by the instrument he or she teaches (e.g., guitar, bass, keyboards, etc.) and by a style of music. Within the style category 304, each teacher may be placed in one or more areas, such as Electric Blues, Acoustic Blues, Rock, Jazz, Classical, Folk/Acoustic, Beginning/Novice, Early Childhood, Senior Citizen, Special Education/Music Therapy. These categories may be further sub-divided into sub-categories. For example, a sub-category may have one or more associated “artists.” The artist may be used to both identify each teacher's specialty and help students identify the specific sub-style they wish to study. For example, the style may be Electric Blues and the sub-style may be Eric Clapton. In either instance, the student is let to the same teacher's lesson track.

Examples of style categories and subcategories may include:

Electric Blues

Chicago (Eric Clapton, B. B. King)

Texas (Stevie Ray Vaughan, Freddie King)

Rock (Jimi Hendrix, Jimmy Page)

Jazz/Swing (George Benson, Grant Green)

Acoustic Blues

Delta (Muddy Waters, Robert Johnson)

Ragtime (Blind Lemon Jeffereson)

Country Blues (Jerry Read, Jerry Donahue)

Slide (Muddy Waters)

Rock

1950's (Chuck Berry, Bo Diddley)

1960's (Eric Clapton, Jimi Hendrix)

1970's (Santana, Jeff Beck, Jimmy Page)

1980's (Eddie Van Halen, Joe Satriani, Steve Vai)

1990's (Trey Anasataio, Eric Johnson)

Jazz

Swing/Gypsy (Freddie Green, Django Reinhardt)

Be-Bob (Charlie Christian)

Hard Bob (Cannonball Adderly)

Soul Jazz (Wes Montgomery, George Benson)

Cool Jazz (Miles Davis)

Latin (Gilberto)

Fusion (Coryell, Al Dimeola)

Modern (Metheny, Scofield)

Classical

Folk/Acoustic

Traditional (Pete Seeger)

Popular (Paul Simon)

Country (Doc Watson)

New Country (Rick Scaggs)

Bluegrass (Tony Rice)

Modern Acoustic (Michael Hedges, Leo Koettke)

Beginning/Novice

Acoustic

Electric

Early Childhood

Senior Citizen

Special Education/Music Therapy

Within each area of expertise, an instructor is further categorized and ranked according to the level of student he or she proves to be successful teaching 306, such as Beginner, Intermediate, and Advanced. For example, a Blues teacher specializing in electric Blues, sub-style Chicago may prove to be more successful teaching beginner students. In this case, the teacher's ranking indicates that he or she specializes in instructing students at a beginning level.

Each instructor is also ranked by the age of the student they prove to be most successful teaching 307. For example, a teacher may be more successful teaching adults rather than teenagers. Hence, adult students would be led to this instructor while teenage students would be led to an instructor with greater historical success teaching younger students.

Different instructors may approach content from a specific point of view. Consequently, each teacher is also categorized and ranked by the unique methodology he or she employs when teaching 308. For example, an instructor may approach a particular subject from a theoretical point of view, while another will approach the same subject from the point of view of rote learning. Each teacher is assigned a rank based on his or reliance on use of theory and technical terms, use of rote learning methods, use of standard music notation, and use of non-standard music notation (e.g., tablature).

Each teacher may also be categorized and ranked by his or her teaching philosophy. Further, each teacher may create a 90-second video that explains their approach to teaching. A student may access these videos through a graphical user interface (e.g., see FIG. 3) at any convenient time, such as when he or she 1) is led to the appropriate teacher's lesson track, 2) searches the system using a specified keyword, such as “teacher,” or 3) searches the system using a teacher's name.

A teacher also may be categorized and ranked by different personality traits 309 he or she exhibits and employs in a teaching session. Exemplary personality traits may include sense of humor, that he or she follows a strict lesson plan, or that the teacher proceeds through his or her lessons in a more relaxed or idiosyncratic format. A teacher also may be considered as having certain degrees of nurturing, creativity, and/or informality in the way that he or she deals with students or conducts a lesson. Each teacher also may be categorized and ranked by gender 310.

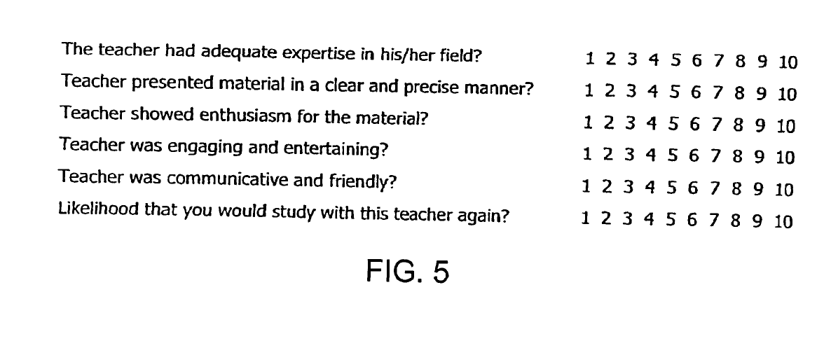

A teacher also may be categorized and ranked according to his or her student ranking 311. In illustrative embodiments and as noted above, each teacher 204 is evaluated on an on-going basis by his or her students. At the end of each lesson track (typically 10 to 15 lessons), a student is asked to evaluate the experience and, more specifically, the teacher, based upon a number of areas. FIG. 5 shows exemplary criteria presented to a student to help the student evaluate a teacher. A student responds to each of the questions by ranking the teacher on a scale of 1 to 10, where 10 is the highest ranking. The system tabulates an overall ranking of the teacher by averaging the scores that the teacher receives. Teachers with high rankings and more students are given the opportunity to create more lesson tracks. Such a teacher may either amend and/or expand an existing track or develop a new track.

The system also provides an automated evaluation of each teacher and calculates a number of factors that quantify a teacher/student relationship. These factors may include the time spent on each lesson, the time spent on each segment within a lesson, the number of times a student takes a specific lesson, and the average test scores that students receive after each lesson. These variables are used to judge teacher effectiveness and student usage.

Students may have a successful educational experience for a number of reasons. The system evaluates the kinds of students that are successful with a particular teacher by accessing a student profile. Teachers are categorized and ranked in accordance with a system analysis of successful students 312 of a particular teacher. For example, if a specific group of students is more successful than others working with a teacher, the system may analyze these students' profiles to determine common threads. When the system finds commonality, it amends a teacher's attributes to make note of this common factor. If the students who rank their experience as excellent (e.g., a 9 or 10) categorize themselves as visual learners, then the rank associated a teacher's analysis of successful students will reflect that the teacher is more likely to be the appropriate teacher for visual learners within a specified category. The ranks associated with the analysis of successful students combined with the other teacher related categories, guides the system in determining 1) which teacher(s) should be accessed by a particular student, 2) which teachers should be contracted to create additional content, and 3) which additional lesson tracks these teachers should create.

Illustrative embodiments also electronically profile students. After the pertinent information is obtained, a student's profile is stored in a student database 206 (FIG. 2) that communicates with the education service provider 201. The teacher database 205 and student database 206 may be resident on a server 207 that is also in communication with the education service provider 201. Analysis of a particular student's profile, in connection with at teacher's profile, provides a basis for the student's educational experience. An individual student may be exposed to multiple instructors 204 for a particular curriculum, as well as a three-dimensional educational construct (explained in detail below), wherein a student may access multiple lesson tracks incorporating multiple styles and multiple instructors. Further, the student's interests, experience and learning skill set (i.e., whether a student is a visual, auditory, kinesthetic, or tactile learner) also may be profiled. Accordingly, the system matches the appropriate teacher and lesson track to a given student.

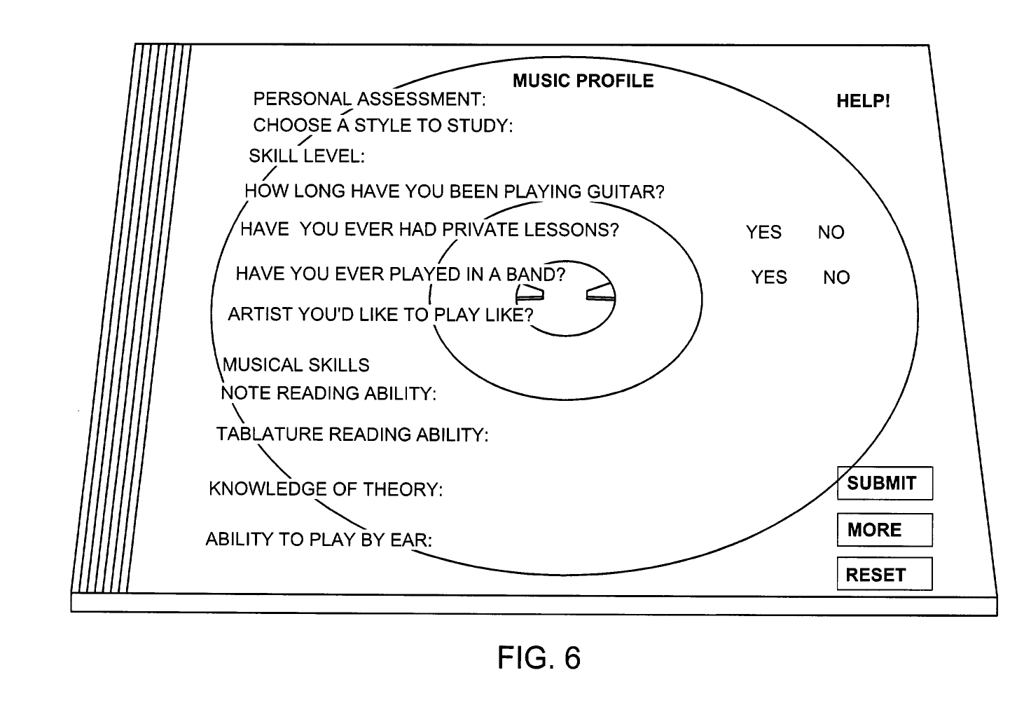

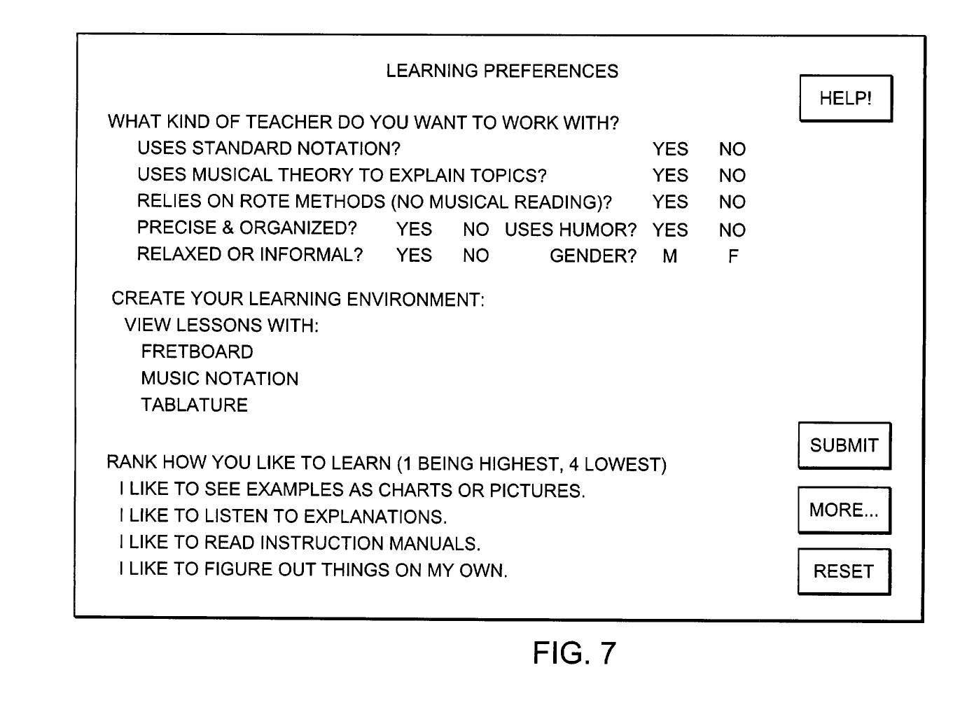

The system thus creates a student's profile when a student responds to questions displayed on an interactive graphical user interface (e.g., the interfaces shown in FIGS. 6 and 7). Among other things, the profile may include the student's musical interests, experience and learning skills. After the student's profile is completed, he or she may be matched to an appropriate curriculum and teacher, and a group of lesson segments may be established for that student. The student may be able to access each lesson segment through the network at his or her own pace. Further, as suggested above and noted below, the student has access to a plurality of instructors and a multi-dimensional educational construct that is designed to a enable the student to traverse different musical styles, teaching styles, and learning styles.

The profiling procedure, when conducted via an electronic site, is relatively straight forward. For example, a guitar student may be asked a series of questions through an interactive graphical user display that may include the following:

What style of music are you interested in?

The student may select from a plurality of musical styles such as Blues, Rock, Jazz, Folk/Acoustic and novice (indicating the student does not have a preferred style). The answer to this question may trigger a drop down box that lists a plurality of artists within the chosen style.

Which artist you wish to play like?

As an example, if the student has chosen Blues as the style of music he or she is interested in, he or she may select from a group of artists such as B. B. King, Albert King, Eric Clapton, Stevie Ray Vaughan, etc. Similarly, if the student has chosen Rock as the style of music he or she is interested in, he or she may select from a group of artists such as the Eddie Van Halen and other Rock and roll guitarists.

What skill level have you attained?

The student may select from a group of skill levels such as novice, beginner, intermediate and advanced.

Have you ever taken private lessons?

The student may select yes or no.

Do you play in a band?

The student may select yes or no.

Can you read standard music notation?

The student may select from a group indicating that his or her ability to read standard notation is at a level corresponding to novice, beginner, intermediate, or advanced.

Can you read tablature?

The student may select from a group indicating that his or her ability to read tablature is at a level corresponding to novice, beginner, intermediate, or advanced.

What is your understanding of musical theory?

The student may select from a group indicating that his or her understanding of musical theory is at a level corresponding to novice, beginner, intermediate, or advanced.

Can you play by ear?

The student may select from a group indicating that his or her ability to play by ear is at a level corresponding to novice, beginner, intermediate, or advanced. At this point the student can submit these answers through the electronic site and an appropriate teacher and lesson track will be suggested, or the student can go deeper into the profiling system to answer additional questions, such as the following:

Do you want to work with a teacher that uses standard music notation?

The student may select yes or no.

Do you want to work with a teacher who uses music theory in his or her explanations?

The student may select yes or no.

Do you want to work with an instructor that teaches by rote?

The student may select yes or no.

Do you want a teacher who is precise and organized?

The student may select yes or no.

Do you want a teacher who is relaxed and informal?

The student may select yes or no.

Do you want a teacher who uses humor?

The student may select yes or no.

Do you want to work teacher who is male or female?

The student may select male or female.

What do you want your learning environment to look like?

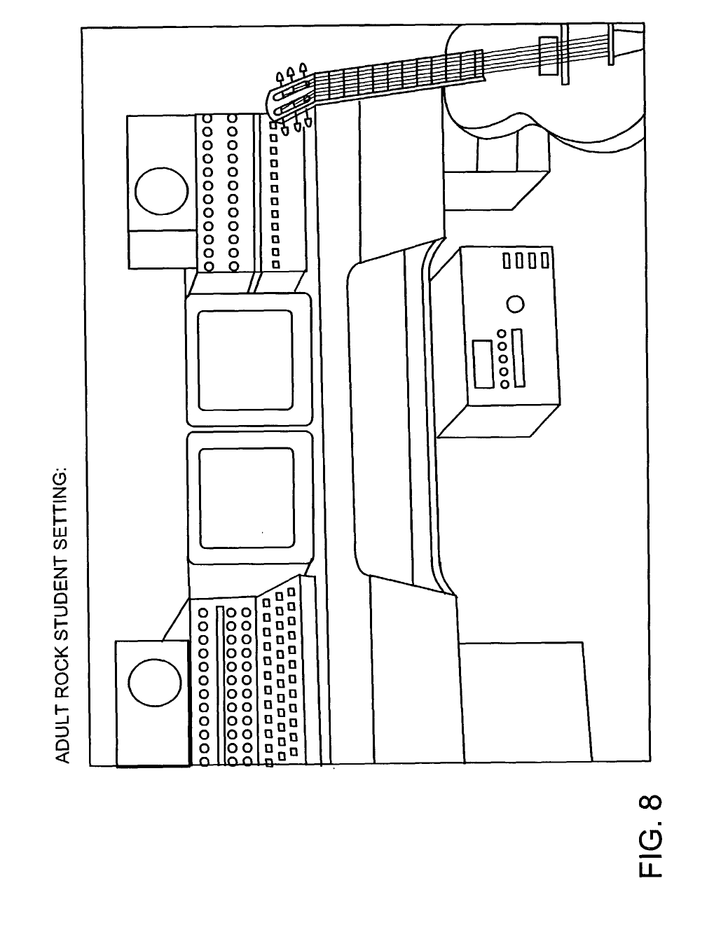

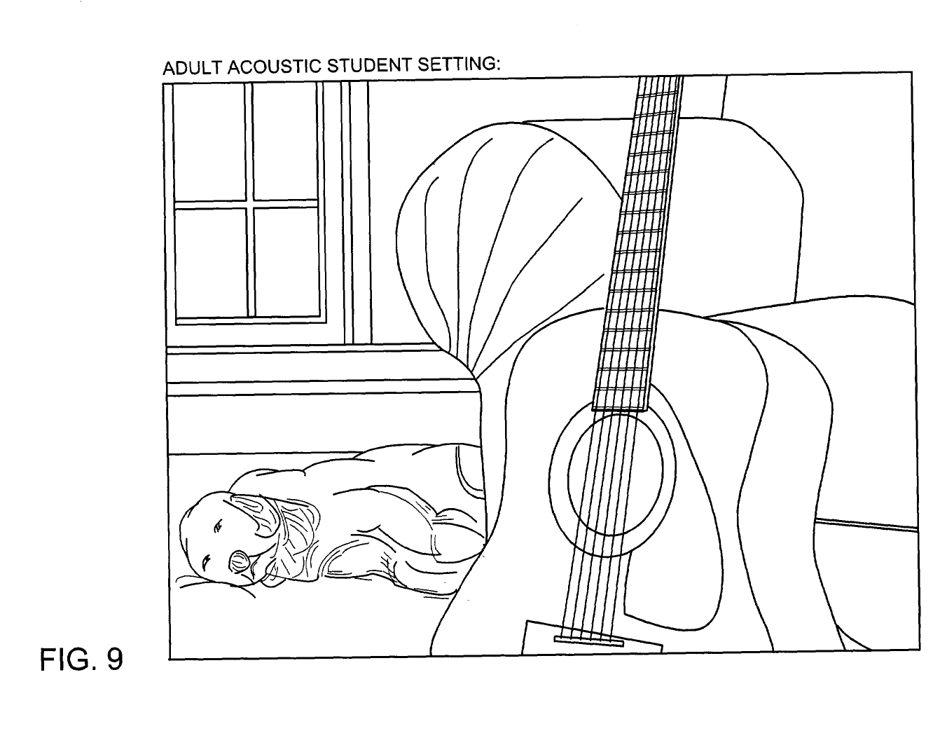

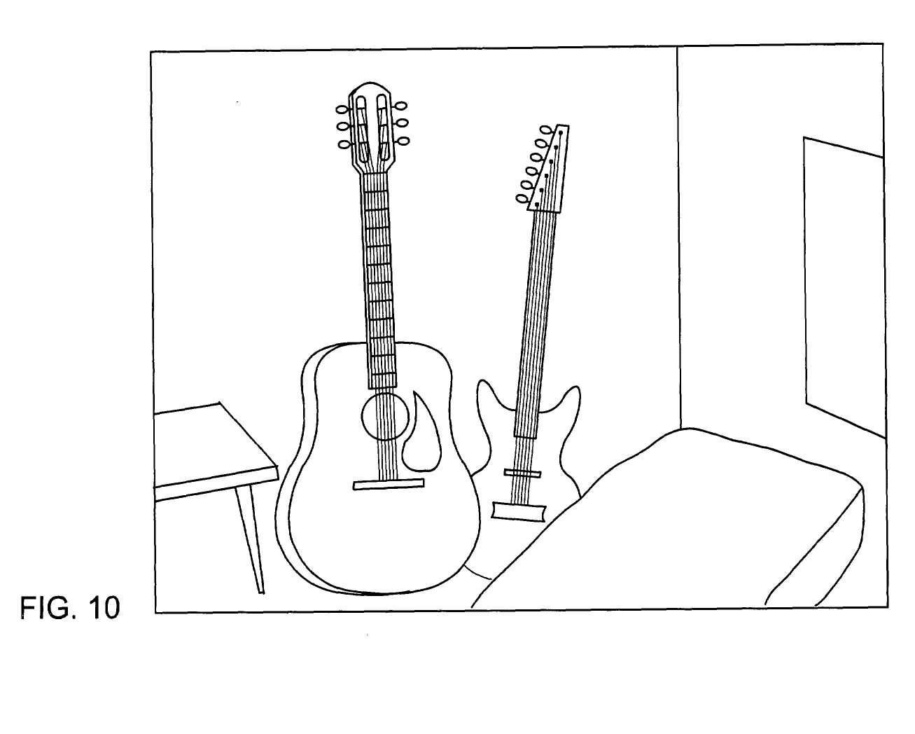

Student profiling also affects a student's learning environment when receiving lessons. Specifically, the profile determines the type of interface/display to be used when the student is accessing lessons. Exemplary background environments are illustrated in FIGS. 8-10. Graphics, menu bars and voice-overs are matched to a student's age, the style of music the student is studying and the student's gender. For example, an adult Rock guitar student is matched with a specific menu bar, learning desktop, voice over and home page as shown in FIG. 8. In contrast, a 16 year old male Rock guitar student may be exposed to a completely different graphic and audio experience, as shown in FIG. 10, while an adult Acoustic guitar student may be exposed to yet another graphic and audio experience, as shown in FIG. 9. In addition, a student may choose particular educational tools he or she wishes to see displayed during a particular lesson. For example, a display may include an animated fret-board, standard music notation, or tablature notation.

In order to ascertain the student's preferred learning style or skill set, (i.e., visual, auditory, kinesthetic or tactile) the student may also be asked to rank the importance of the following phrases to describe how they learn:

I like to view charts and pictures.

If a student gives this statement a high ranking, it would indicate that the student is a visual learner.

I like to listen to explanations.

If a student gives this statement a high ranking, it would indicate that the student is an auditory learner.

I like to read instructional manuals.

If a student gives this statement a high ranking, it would indicate that the student is a refined auditory learner.

I like to figure things out on my own.

If a student gives this statement a high ranking, it would indicate that the student is a kinesthetic or tactile learner.

The student may submit his or her answers through the electronic site and be directed to an appropriate lesson track.

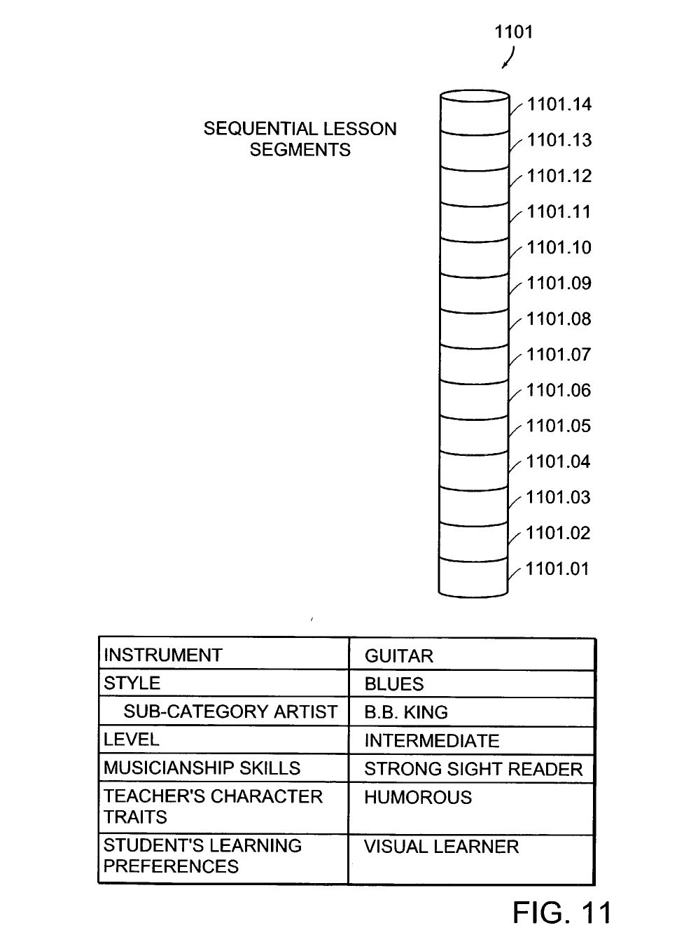

FIG. 11 shows a block diagram of a lesson track 1101 organized in accordance with an illustrative embodiment of the invention. Specifically, the lesson track 1101 is a group of lessons that are categorized by a number of different criteria, such as musical instrument, musical style, skill level, musical skill set, teacher character preferences and learning skill set. For example, in the lesson track shown in FIG. 11, the instrument to be studied may be a guitar and the style of guitar playing incorporated in the lesson track may be a Blues style. The skill level of the student in the given track is intermediate and the musical skill set of the student includes the student's accomplishment in reading standard music notation. Additionally, the preferred teacher character traits for the student include humor in the teacher's presentation of the material, and the learning skill set of the student includes a propensity toward visual learning.

The lesson tracks may typically include 15-20 sequential lessons. Each lesson may run a predetermined amount of time (such as 5-90 minutes). Each of the component lessons covers a specific content theme. For example, a lesson may by designed to instruct a student to incorporate improvisation using a specific pentatonic scale with respect to a guitar. Each lesson may employ video for viewing someone performing the subject matter of the lesson properly and audio for hearing a teacher speak, other students speak, and in the case of a musical lesson, hearing someone play the subject matter of the lesson properly. The lesson may also include a text display, standard music notation display, tablature display, and an animated fret-board wherein the student may follow the where fingers should be placed in accordance with notes and chords. Each lesson may also include diagrams and playback and forward features.

For purposes of FIGS. 11-16, a specialized numbering scheme is employed. In accordance with this numbering scheme, the first two digits to the left of the decimal point represent a particular teacher. The third and fourth digits to the left of the decimal point represent a style of music and the digits to the right of the decimal point represent a particular lesson within the lesson track. The table below provides a key to the number scheme:

Blues Style 1100

| Blues Teacher 1 1101 | |
|---|---|
| Blues Teacher 1 Lessons 1-14 | 1101.01-1101.14 |
| Blues Teacher 2 1102 | |
| Blues Teacher 2 Lessons 1-14 | 1102.01-1102.14 |
| Blues Teacher 3 1103 | |
| Blues Teacher 3 Lessons 1-14 | 1103.01-1103.14 |
| Blues Teacher 4 1104 | |
| Blues Teacher 4 Lessons 1-14 | 1104.01-1104.14 |

Rock Style 1200

| | |
|---|---|
| Rock Teacher 1 1201 | |
| Rock Teacher 1 Lessons 1-14 | 1201.01-1201.14 |
| Rock Teacher 2 1202 | |
| Rock Teacher 2 Lessons 1-14 | 1202.01-1202.14 |
| Rock Teacher 3 1203 | |
| Rock Teacher 3 Lessons 1-14 | 1203.01-1203.14 |
| Rock Teacher 4 1204 | |
| Rock Teacher 4 Lessons 1-14 | 1204.01-1204.14 |

Jazz Style 1300

| | |
|---|---|
| Jazz Teacher 1 1301 | |
| Jazz Teacher 1 Lessons 1-14 | 1301.01-1301.14 |
| Jazz Teacher 2 1302 | |
| Jazz Teacher 2 Lessons 1-14 | 1302.01-1302.14 |
| Jazz Teacher 3 1303 | |
| Jazz Teacher 3 Lessons 1-14 | 1303.01-1303.14 |
| Jazz Teacher 4 1304 | |
| Jazz Teacher 4 Lessons 1-14 | 1304.01-1304.14 |

Acoustic Style 1400

| | |
|---|---|
| Acoustic Teacher 1 1401 | |
| Acoustic Teacher 1 Lessons 1-14 | 1401.01-1401.14 |
| Acoustic Teacher 2 1402 | |
| Acoustic Teacher 2 Lessons 1-14 | 1402.01-1402.14 |
| Acoustic Teacher 3 1403 | |
| Acoustic Teacher 3 Lessons 1-14 | 1403.01-1403.14 |
| Acoustic Teacher 4 1404 | |
| Acoustic Teacher 4 Lessons 1-14 | 1404.01-1404.14 |

Classical Style 1500

| | |
|---|---|
| Classical Teacher 1 1501 | |
| Classical Teacher 1 Lessons 1-14 | 1501.01-1501.14 |
| Classical Teacher 2 1502 | |
| Classical Teacher 2 Lessons 1-14 | 1502.01-1502.14 |
| Classical Teacher 3 1503 | |
| Classical Teacher 3 Lessons 1-14 | 1503.01-1503.14 |
| Classical Teacher 4 1504 | |
| Classical Teacher 4 Lessons 1-14 | 1504.01-1504.14 |

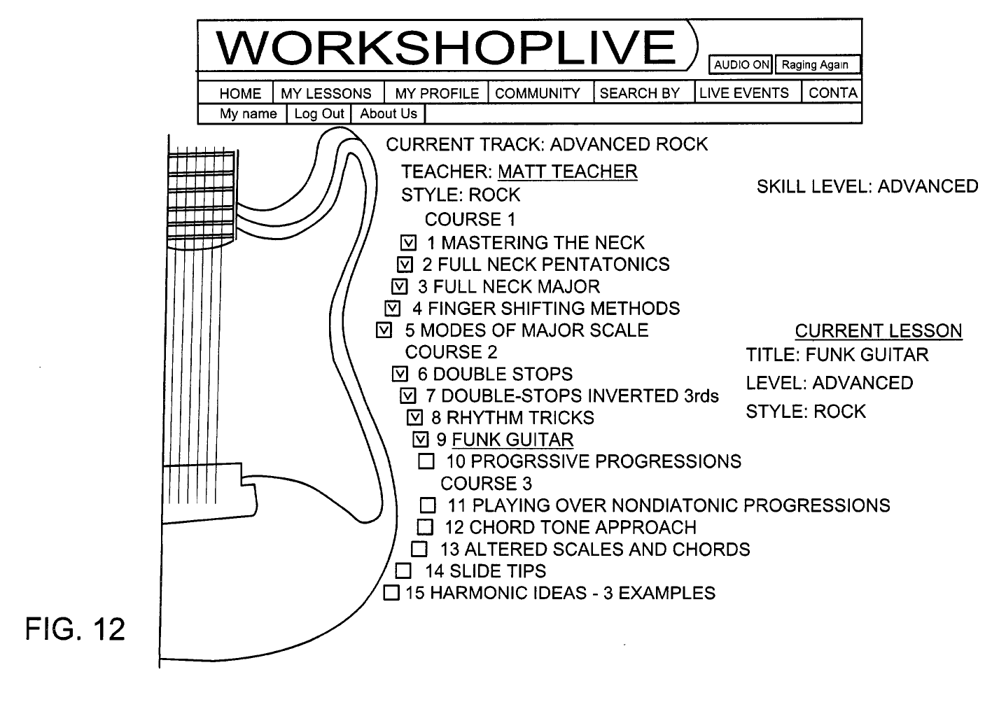

To these ends, each block 1101.01-1100.14 of the lesson track 1101 represents a sequential lesson segment that is based upon the character preferences and learning skill sets noted above. A student thus may complete segment 1101.01 and move on to segment 1101.02 at his or her own pace. Further, the student may traverse the lesson segments 1101.01-1100.14 in the lesson track 1101 at his or her own discretion. Thus, if the student has reached lesson segment 1101.07 and would like to repeat lesson segment 1101.04 to refresh his or her knowledge of skills and topics presented in lesson segment 1101.04, he or she is free to do so. An interactive graphical interface for displaying a student's lesson track is illustrated in FIG. 12.

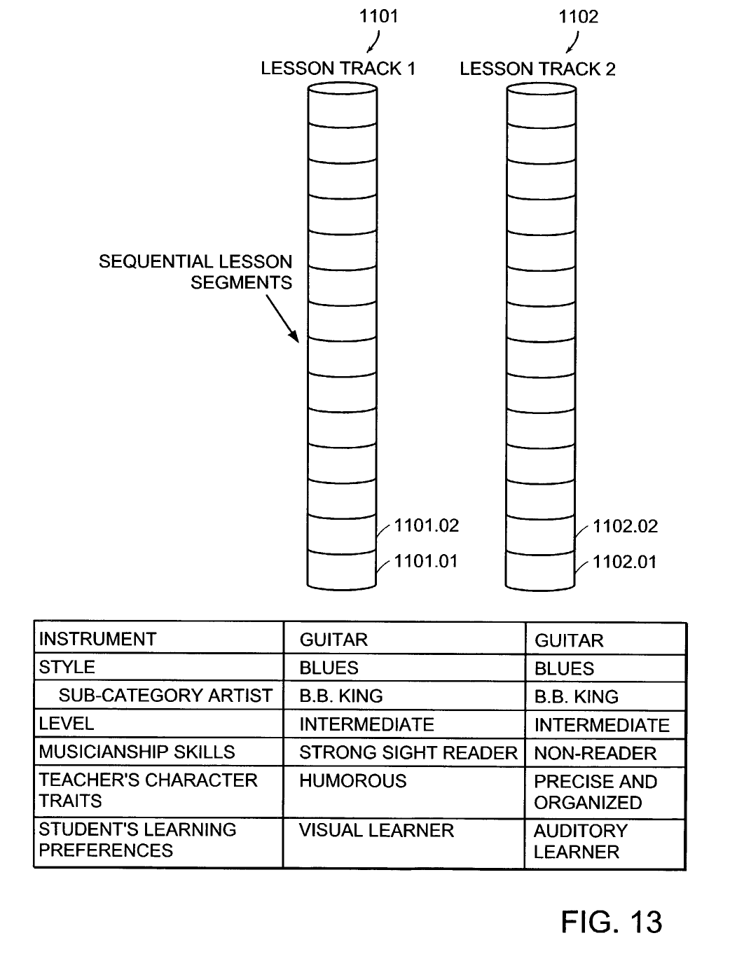

The lesson track 1101 represents a group of lessons constructed by a particular teacher. A lesson track constructed by another teacher whose expertise includes Blues guitar instruction may have a lesson track designated 1102, as shown in FIG. 13. FIG. 13 illustrates multiple lesson tracks 1101 and 1102. Specifically, the system may incorporate multiple lesson tracks to both accommodate a specific musical instrument and a specific musical style. Although they have this similarity, the tracks 1101 and 1102 nevertheless are directed to different the musical skill sets, teacher character traits, and learning skill sets. For example, the second lesson track 1102 may have the following attributes: 1) the instrument to be studied is a guitar, 2) the style is Blues, and 3) intermediate student skill level. However, the musical skill set of the student does not indicate that the student is accomplishment in reading standard music notation, the preferred teacher character traits for the student indicate that the student learns best when given a precise, organized presentation of the material, and the learning skill set of the student indicates that the student exhibits a propensity toward auditory learning. Blocks 1102.01 and 1102.02 represent sequential lesson segments that may correspond to topics covered the lesson segments of blocks 1101.01 and 1101.02, respectively, of lesson track 1101.

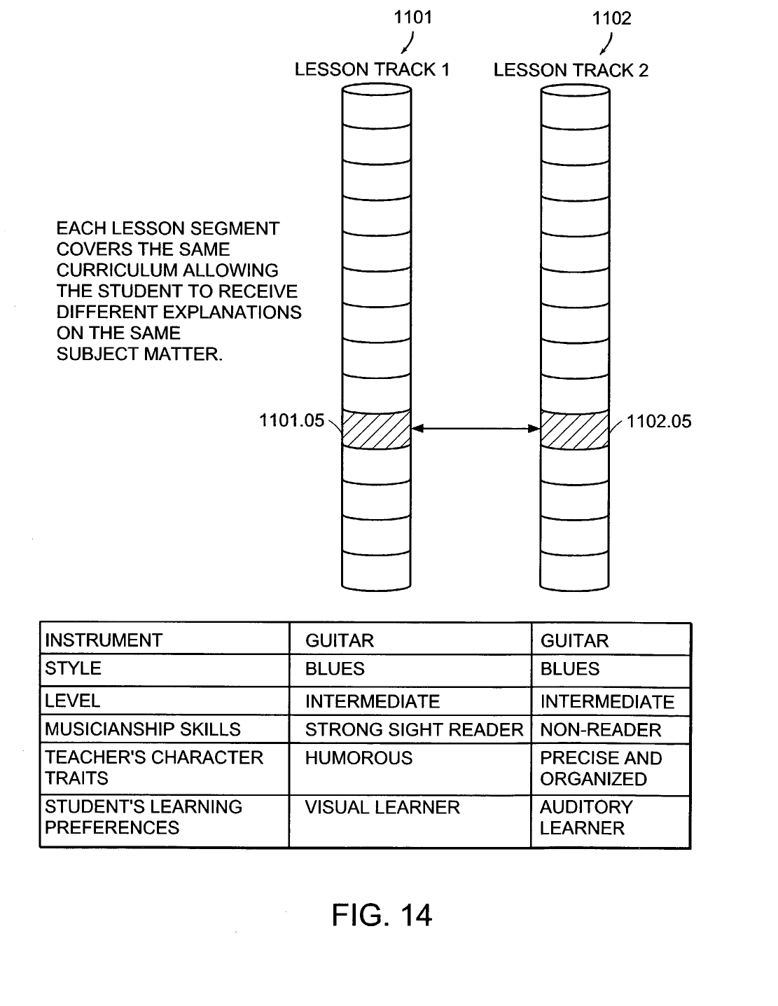

By setting up a variety of lesson tracks for each instrument, musical style, and skill level, a student may move horizontally from teacher to teacher to receive different explanations of similar topics as shown in FIG. 14. For example, a student receiving lesson segment 1101.05 of lesson track 1101 (i.e., being instructed by a teacher who includes humor in his or her presentation) may wish to hear an explanation of the subject matter of lesson segment 1101.05 by a teacher who is more precise and organized. The student can access lesson segment 1102.05 of lesson track 1102 at his or her own discretion. In this manner, the student is instructed on a similar topic by a teacher with a different style. This parallel instruction is at a level appropriate for the student and conducted in a manner that is consistent with both the style of music the student wishes to learn and the student's individual learning needs and skills.

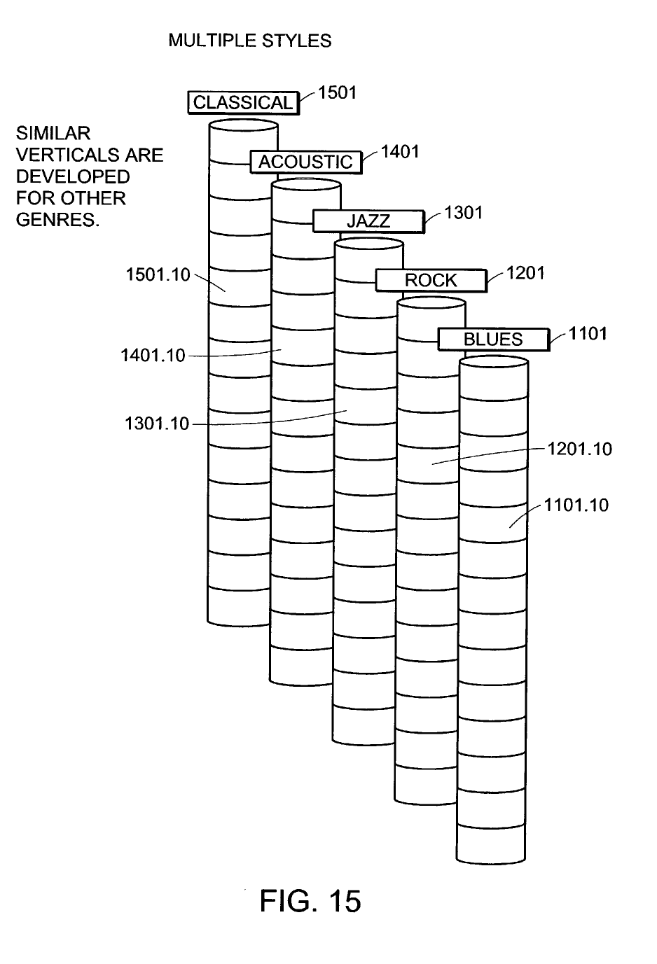

FIG. 15 illustrates separate lesson tracks for a plurality of guitar playing styles. Lesson track 1501 represents lessons devised for a Classical style by a particular Classical style teacher. Lesson track 1401 represents lessons devised for an Acoustic style by a particular Acoustic style teacher. Lesson track 1301 represents lessons devised for a Jazz style by a particular Jazz style teacher. Lesson track 1101 represents lessons devised for a Rock style by a particular Rock style teacher. Lesson track 1101 represents lessons devised for a Blues style by a particular Blues style teacher. A student pursuing a Classical lesson track and receiving lesson segment 1501.10 of lesson track 1501 may desire to hear a similar lesson segment pertaining to a different musical style. The student may access lesson segment 1101.10 of lesson track 1101 to receive a similar lesson incorporating a Blues style. Similarly, the student may access lesson segments 1401.10, 1302.10 or 1201.10 to receive lessons incorporating Acoustic, Jazz or Rock styles respectively.

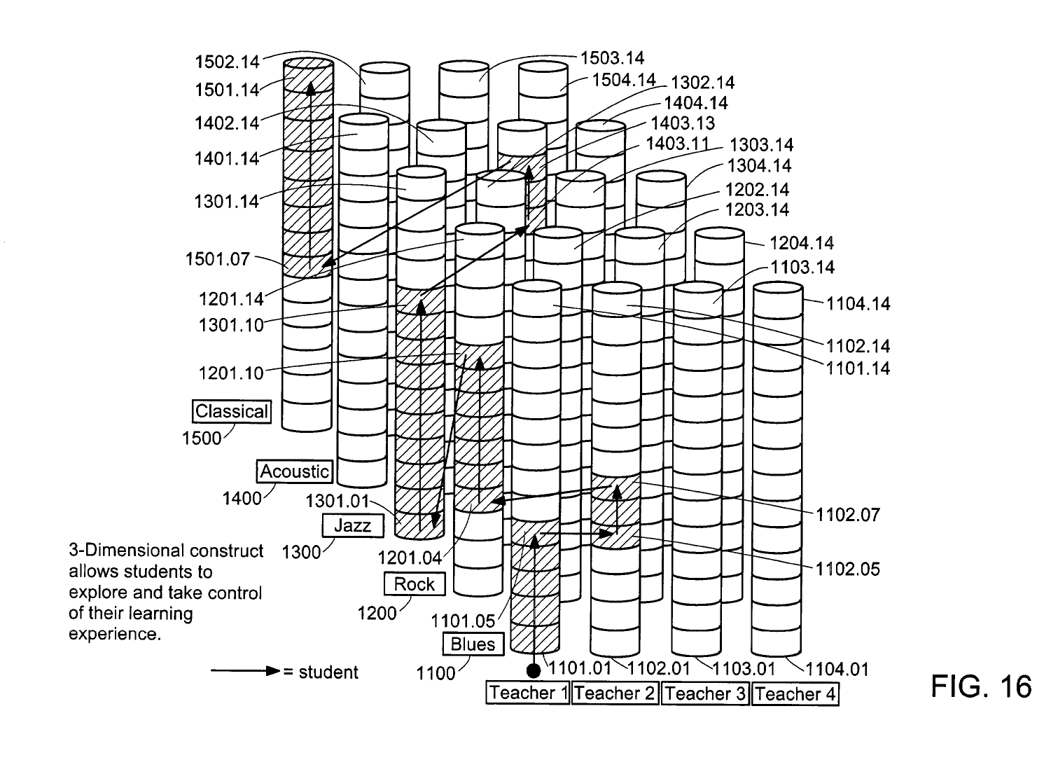

FIG. 16 illustrates a multi-dimensional education construct wherein a student may access multiple lesson tracks incorporating multiple styles and multiple instructors. Here, each of a plurality of teachers 1101-1104, 1201-1204, 1301-1304, 1401-1404, 1501-1504 provides instruction to students in accordance with a plurality of music styles 1100-1500. More specifically, in the Blues category 1100 may have four different teachers 1101-1104 associated with it. Each Blues teacher 1101-1104 devises a lesson track having a plurality of lessons. For example, Blues teacher 1101 devises a lesson track including lessons 1101.01-1101.14. Blues teacher 1102 devises a lesson track including lessons 1102.01-1102.14. Blues teacher 1103 devises a lesson track including lessons 1103.01-1103.14. Blues teacher 1104 devises a lesson track including lessons 1104.01-1104.14.

Similarly, Rock teachers 1201 and 1202 devise lesson tracks including lessons 1201.01-1200.14 and 1202.01-1202.14 respectively. Jazz teachers 1303 and 1304 devise lesson tracks including lessons 1303.01-1303.14 and 1304.01-1304.14 respectively. Acoustic teachers 1402 and 1403 devise lesson tracks including lessons 1402.01-1402.14 and 1403.01-1403.14 respectively and Classical teachers 1501 and 1502 devise lesson tracks including lessons 1501.01-1501.14 and 1502.01-1502.14 and so on.

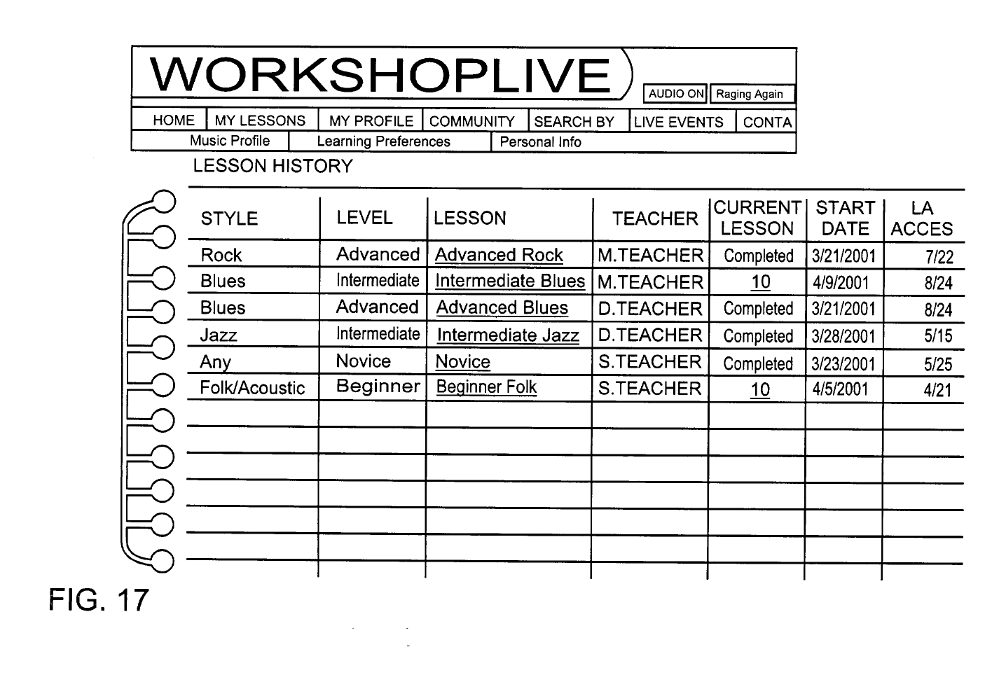

The multi-dimensional educational construct noted above that enables a student to traverse lesson segments in each lesson track, and lesson tracks of different teachers. As graphically illustrated in FIG. 16 by arrows, a student may move through the construct vertically (to experience the various lesson segments), horizontally (to experience the various instructors), and diagonally (to experience the various musical styles) as shown by the arrows in the diagram. For example, a student accessing lesson 1101.05 of Blues teacher 1101 may first access lesson 1102.05 of Blues teacher 1102, move on to lesson 1102.07 of Blues teacher 1102 and then move to lesson 1201.04 of Rock teacher 1201. The student may then sequentially (or non-sequentially) access lessons 1201.05-1201.10 of Rock teacher 1201 and move on to sequentially (or non-sequentially) access lessons 1301.01-1301.10 of Jazz teacher 1301. Similarly, the student may then access lessons 1403.11-1403.13 of Acoustic teacher 1403, and move on to access lessons 1501.07-1501.14 of Classical teacher 1501. A student may also access an interactive graphical user interface, as shown in FIG. 17, to see a history of lessons that the student has taken and to repeat a lesson or proceed to the next sequential lesson.

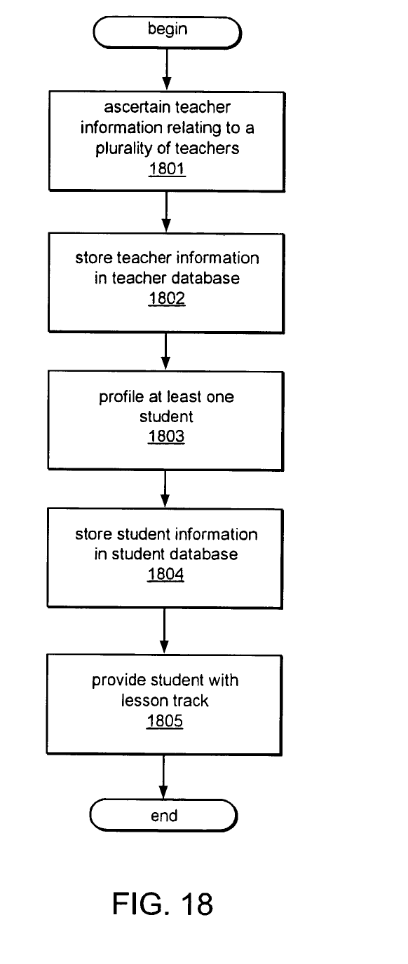

FIG. 18 shows an illustrative method for providing educational instruction over a network in accordance with an embodiment of the invention. The process begins at step 1801 by ascertaining teacher information relating to a plurality of teachers. The teacher information is stored in the teacher database 205 (step 1802). The teacher database may include the teacher profile and teacher generated lesson tracks. The process continues to step 1803, in which at least one student is profiled via the network. That information then is stored in a student database 206 (step 1804). The system provides a lesson track to the student devised by a primary teacher in accordance with analyzed information (step 1805). Providing the student with a lesson track may include providing the lesson track over the network via an interactive graphical user interface.

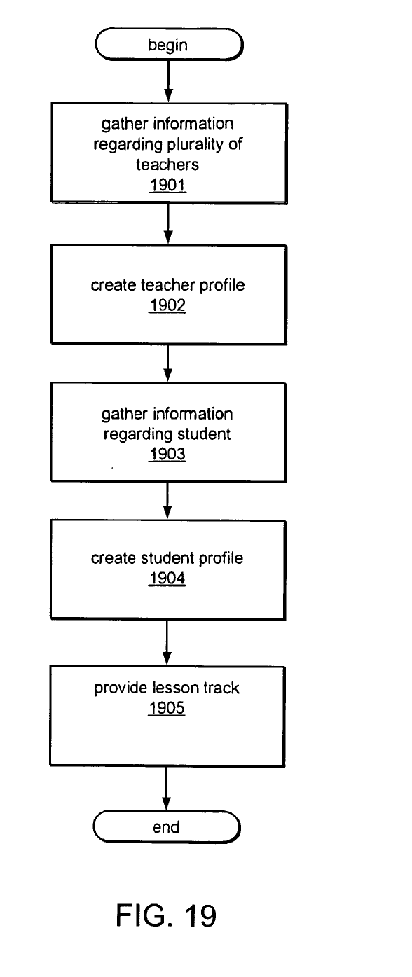

FIG. 19 shows an illustrative method for providing educational instruction over a network in accordance with another embodiment of the invention. In accordance with this embodiment, information relevant to a plurality of teachers is gathered either electronically via a electronic site, or manually (step 1901). A teacher profile is created for each teacher in accordance with each teacher's expertise and style of teaching (step 1902). As mentioned above, a teacher may then create synchronous learning experiences (such as “live” group lessons) and asynchronous lesson tracks. Information relevant to at least one student is gathered (step 1903) via a network and a student profile is created (step 1904) based on the student information. The student is provided with a lesson track via the network based on analysis of the teacher profile and the student profile (step 1905).

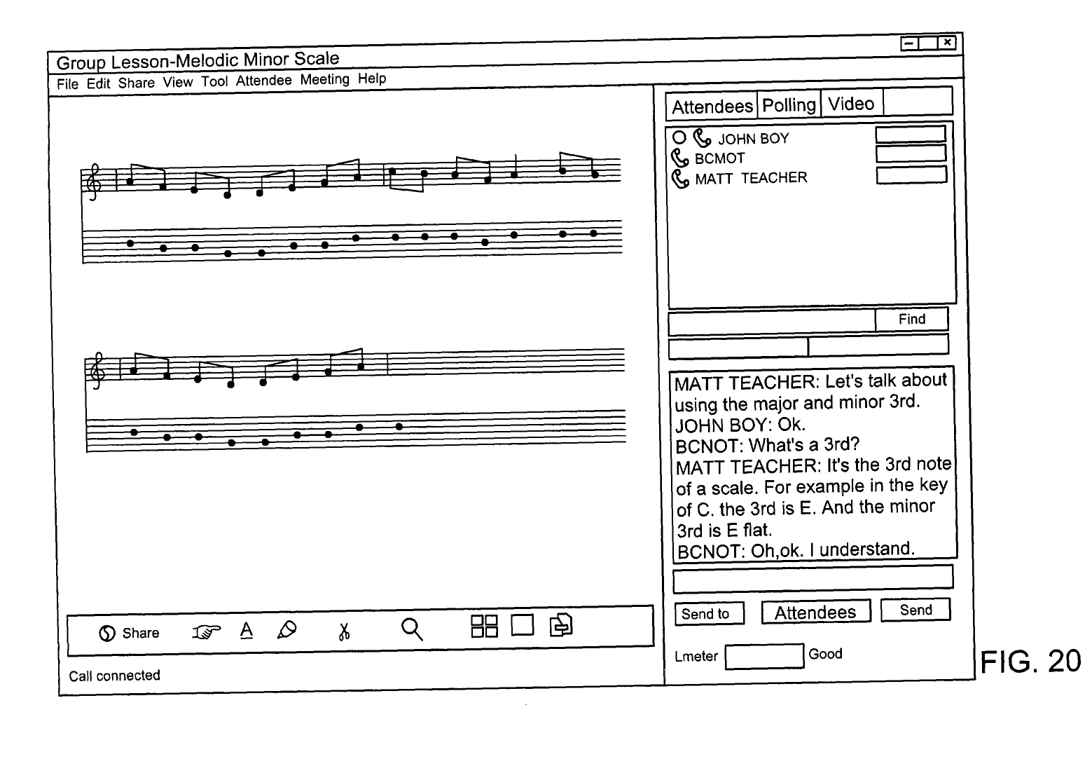

In a manner similar to many learning environments, community interaction (e.g., peer interaction) is an important component of the educational experience. To these ends, illustrative embodiments encourage students working with a particular teacher to work together online. The education service provider 201 thus assigns virtual classrooms and chat rooms to students according to teacher and lesson track. Students receive an electronic message (e.g., see FIG. 20) inviting them to exchange ideas with other students at a pre-arranged time in virtual classrooms. Information concerning these events, including time and subject, are displayed to the student via a graphical interface, such as that shown in FIG. 20. Students may access events for a particular day of the week through drop down menus 2101-2107. A teacher may also be available to take part in these activities. Students also may be notified in real time when other students join the same lesson that they are using. At that point, they can choose to enter a chat room with the other students.

Alternative embodiments of the invention may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions preferably embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed and described, it should be apparent to those skilled in the art that various changes and modifications can be made which will achieve some of the advantages of the invention without departing from the true scope of the invention. The discussed embodiments are thus to be considered as illustrative and not restrictive. These and other obvious modifications are intended to be covered by the appended claims.

What is claimed is:

1. A system for providing educational instruction to a student over a computer network, the system comprising:
an education service provider in communication with the computer network;
a teacher database containing teacher information relevant to a plurality of teachers; and
a student database containing student information relevant to at least one student,
the education service provider being capable of providing a lesson track to the at least one student, the lesson track being produced based upon the teacher information and the student information.

2. A system according to claim 1, wherein the teacher database includes a teacher profile.

3. A system according to claim 1, wherein the teacher database includes teacher generated lesson tracks.

4. A system according to claim 1, wherein the teacher database includes information relevant to each teacher's teaching philosophy.

5. A system according to claim 1, wherein the teacher database includes information relevant to each teacher's personality traits.

6. A system according to claim 1, wherein the teacher database includes a rank for each teacher based on student input.

7. A system according to claim 1, wherein the teacher database includes a rank for each teacher based on analysis by the education service provider.

8. A system according to claim 1, wherein the network is the Internet.

9. A system according to claim 1, wherein the lesson track is provided to the student over the network via an interactive graphical user interface.

10. A system according to claim 9, wherein the interactive graphical user interface is customized for the student based on information in the student database.

11. A system according to claim 1, wherein the education service provider matches a primary teacher to the student in accordance with the teachers' expertise and style of teaching and with the student's education preferences and provides the student with a lesson track devised by the primary teacher.

12. A system according to claim 11, wherein the education service provider further provides the student with a lesson track devised by one or more secondary teachers.

13. A method for providing educational instruction to a student over a network, the method comprising:
ascertaining teacher information relating to a plurality of teachers;
storing the teacher information in a teacher database;
profiling at least one student via the network;
storing student information relevant to the student's profile in a student database;
providing the student with a lesson track based upon the teacher information and the student information.

14. A method according to claim 13, wherein storing teacher information includes storing a teacher profile for each teacher and one or more lesson tracks generated by each teacher.

15. A method according to claim 13, further comprising;
storing information relevant to each teacher's teaching philosophy in the teacher database.

16. A method according to claim 13, further comprising:
storing information relevant to each teacher's personality traits in the teacher database.

17. A method according to claim 13, further comprising:
storing a rank for each teacher based on student input in the teacher database.

18. A method according to claim 13, further comprising:
storing a rank for each teacher based on analysis by the Classical service provider in the teacher database.

19. A method according to claim 13, wherein providing the student with a lesson track includes providing the lesson track over the network via an interactive graphical user interface.

20. A system according to claim 19, further comprising:
customizing the interactive graphical user interface for the student based on information in the student database.

21. A method according to claim 13, further comprising:
matching a primary teacher with the student in accordance with the teachers expertise and style of teaching and with the student's education preferences; and
providing the student with a lesson track devised by the primary teacher.

22. A method according to claim 21, further comprising:
providing the student with a lesson track devised by a secondary teacher.

23. A method for providing education to a student over a network, the method comprising:
gathering information relevant to a plurality of teachers;
creating a teacher profile for each teacher in accordance with each teacher's expertise and style of teaching;
gathering student information relevant to at least one student via a network;
creating a student profile based upon the student information;
providing the student with a lesson track, via the network, based on analysis of the teacher profile and the student profile.

24. A system for providing educational instruction to a student over a network, the system comprising:
an education service provider in communication with the network, the education service provider having an interface for receiving teacher information relevant to a plurality of teachers and for receiving student information relevant to at least one student;
the education service provider providing a lesson track to the at least one student based upon both the student information and the teacher information.

25. A method for educating a student, the method comprising:
ascertaining an area of expertise and a teaching style for each of a plurality of teachers;
ascertaining a learning style and learning preferences of at least one student;
providing the student with one or more teachers and one or more lessons based on the each teacher's area of expertise and style of teaching in conjunction with the student's learning style and learning preferences.

26. A method according to claim 25, wherein providing the student with one or more teachers and one or more lessons based comprises:
inputting information relevant to each teacher's area of expertise and style of learning into a computer-based system; and
inputting information relevant to the student's learning style and learning preferences into the computer-based system;
the computer-based system being programmed to analyze the information, match the one or more teachers to the student in accordance with the information, and output the lessons.

27. A computer program product for educating a student, the computer program product comprising a computer usable medium having computer readable program code including:
program code for ascertaining a learning style and learning preferences of at least one student; and
program code for providing the student with one or more teachers and one or more lessons based on each teacher's area of expertise and style of teaching in conjunction with the student's learning style and learning preferences.

28. A computer program product according to claim 27, further comprising:
program code for ascertaining an area of expertise and a teaching style for each of a plurality of teachers.

29. A computer program product according to claim 27, further comprising: program code for creating a teacher profile for each of the plurality of teachers based on each teacher's area of expertise and teaching style.

30. A computer program product according to claim 27, further comprising:
program code for creating a student profile for the student based upon the student's preferences and style of learning.

31. A computer program product according to claim 28, further comprising: program code for generating a lesson track based on the teacher's area of expertise and teaching style and the student's preferences and style of learning.
